(19) United States
(12) Patent Application Publication
(10) Pub. No.: US 2024/0304367 A1
(43) Pub. Date: Sep. 12, 2024

(54) MULTILAYER COIL COMPONENT

(71) Applicant: Murata Manufacturing Co., Ltd., Kyoto-fu (JP)

(72) Inventors: Makoto YAMAMOTO, Nagaokakyo-shi (JP); Masayuki OISHI, Nagaokakyo-shi (JP)

(73) Assignee: Murata Manufacturing Co., Ltd., Kyoto-fu (JP)

(21) Appl. No.: 18/665,172

(22) Filed: May 15, 2024

Related U.S. Application Data
(63) Continuation of application No. PCT/JP2022/041023, filed on Nov. 2, 2022.

(30) Foreign Application Priority Data
Nov. 19, 2021 (JP) 2021-188649

(51) Int. Cl. H01F 1/36; H01F 5/04

(52) U.S. Cl. CPC H01F 1/36; H01F 5/04

(57) ABSTRACT

A multilayer coil component includes a multilayer body composed of a plurality of laminated insulating layers; a coil composed of a plurality of coil conductors laminated together with the insulating layers, embedded in the multilayer body, and electrically connected; and outer electrodes provided on an outer surface of the multilayer body and electrically connected to the coil. An inorganic material layer is provided in at least part of the interfaces between the insulating layers and the coil conductors. The inorganic material layer includes an inorganic material and a metal material different from the inorganic material. In the inorganic material layer, the metal material is present between particles of the inorganic material or in/between porous bodies made of the inorganic material.

### CROSS-REFERENCE TO RELATED APPLICATIONS

This application claims benefit of priority to International Patent Application No. PCT/JP2022/041023 filed Nov. 2, 2022, and to Japanese Patent Application No. 2021-188649, filed Nov. 19, 2021, the entire contents of each are incorporated herein by reference.

### BACKGROUND

### Technical Field

The present disclosure relates to a multilayer coil component.

### Background Art

Japanese Unexamined Patent Application Publication No. 2006-253322 discloses an electronic component including a body and a coil provided within the body. The body includes a sintered first portion and a second portion located in the first portion and made of a non-sintered powder. The coil is disposed in the second portion and covered with the powder constituting the second portion.

Japanese Unexamined Patent Application Publication No. 2017-59749 (Japanese Patent No. 6520604) discloses a multilayer coil component including a body comprising a magnetic material, a coil including a plurality of inner conductors disposed in the body, spaced apart each other in a first direction, and electrically connected to each other, and a plurality of stress relaxation spaces which are each in contact with the surface of each of the inner conductors and in which a powder is present. The body includes body regions each located between two inner conductors adjacent to each other in the first direction. Each stress relaxation space has a first interface between it and each internal conductor, and a second interface between it and each body region. The first interface and the second interface are opposite to each other in the first direction, and the distance from the first interface to the second interface is smaller than the thickness of the body region in the first direction.

### SUMMARY

Japanese Unexamined Patent Application Publication No. 2006-253322 states that since the coil is disposed in the second portion made of a non-sintered powder, an internal stress generated in the body can be relaxed by the powder constituting the second portion, thereby reducing the formation of cracks. However, since the second portion is made of powder, the electronic component of the document has the problem of low strength of the body.

Japanese Unexamined Patent Application Publication No. 2017-59749 (Japanese Patent No. 6520604) states that since each stress relaxation space, in which powder is present, is in contact with the surface of each internal conductor, and each stress relaxation space is interposed between each internal conductor and each body region, an internal stress generated in the body can be relaxed, thereby reducing the formation of cracks. However, since the stress relaxation spaces are made of powder, the multilayer coil component of the document, like the component of Japanese Unexamined Patent Application Publication No. 2006-253322, has the problem of low strength of the body.

Accordingly, the present disclosure provides a multilayer coil component which can achieve a stress relaxation effect and has a high strength.

A multilayer coil component according to the present disclosure comprises a multilayer body composed of a plurality of laminated insulating layers; a coil composed of a plurality of coil conductors laminated together with the insulating layers, embedded in the multilayer body, and electrically connected; and an outer electrode provided on an outer surface of the multilayer body and electrically connected to the coil. An inorganic material layer is provided in at least part of the interfaces between the insulating layers and the coil conductors. The inorganic material layer comprises an inorganic material and a metal material different from the inorganic material. In the inorganic material layer, the metal material is present between particles of the inorganic material or in/between porous bodies made of the inorganic material.

The present disclosure makes it possible to provide a multilayer coil component which can achieve a stress relaxation effect and has a high strength.

### BRIEF DESCRIPTION OF THE DRAWINGS

FIG. 1 is a perspective view schematically showing an example of a multilayer coil component according to the present disclosure;

FIG. 2 is a cross-sectional view of the multilayer coil component shown in FIG. 1 taken along line II-II in FIG. 1;

FIG. 3 is a cross-sectional view schematically showing an example of an inorganic material layer; and

FIGS. 4A1 to 4A4, FIGS. 4B1 to 4B4, FIGS. 4C1 to 4C4, and FIGS. 4D1 to 4D4 are exploded views schematically illustrating an example of a method for producing a multilayer body having a coil inside.

### DETAILED DESCRIPTION

A multilayer coil component according to the present disclosure will now be described.

It is to be noted that the present disclosure is not limited to the features described below, and various changes and modifications may be made thereto within the spirit and scope of the present disclosure. Two or more preferable features of the present disclosure as described below may be combined; such a combined feature will fall within the scope of the present disclosure.

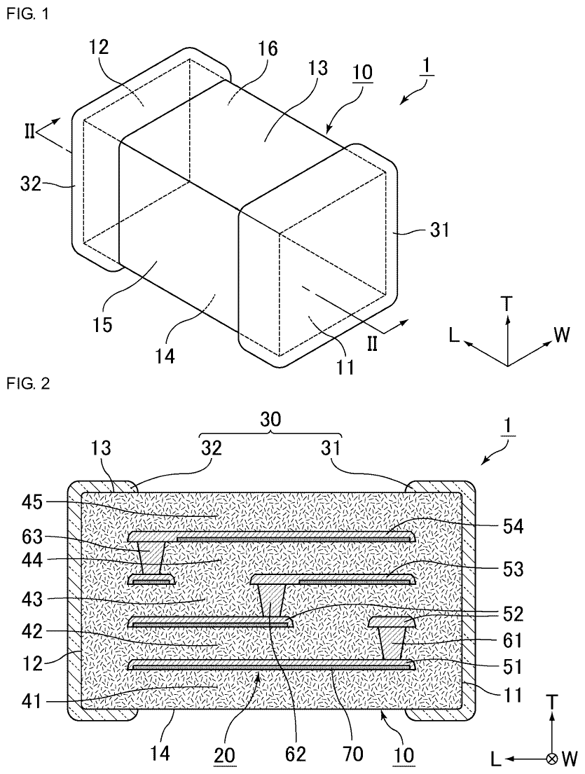

FIG. 1 is a perspective view schematically showing an example of a multilayer coil component according the present disclosure. FIG. 2 is a cross-sectional view of the multilayer coil component shown in FIG. 1 taken along line II-II in FIG. 1. The shapes, positions, etc. of the multilayer coil component and constituent elements are not limited to those illustrated in the figures.

The multilayer coil component 1 shown in FIGS. 1 and 2 includes a multilayer body 10, a coil 20, and outer electrodes 30.

The multilayer body 10 has, for example, a generally rectangular parallelepiped shape with six sides. The multilayer body 10 preferably has rounded corners and ridges. A corner refers to a portion where three sides of the multilayer body 10 intersect, and a ridge refers to a portion where two sides of the multilayer body 10 intersect.

In FIGS. 1 and 2, the length direction, width direction, and height direction of the multilayer coil component 1 and the multilayer body 10 are shown as direction L, direction W, and direction T, respectively. The length direction L, the width direction W, and the height direction T are perpendicular to each other. The mounting surface of the multilayer coil component 1 is, for example, a surface (LW surface) parallel to the length direction L and the width direction W.

The multilayer body 10 shown in FIGS. 1 and 2 has a first end surface 11 and a second end surface 12 opposite to each other in the length direction L, a first main surface 13 and a second main surface 14 opposite to each other in the height direction T perpendicular to the length direction L, and a first side surface 15 and a second side surface 16 opposite to each other in the width direction W perpendicular to the length direction L and the height direction T.

The multilayer body 10 is composed of a plurality of laminated insulating layers (insulating layers 41, 42, 43, 44 and 45 in the example illustrated in FIG. 2). In the example illustrated in FIG. 2, the insulating layers 41, 42, 43, 44 and 45 are laminated along the height direction T. The number of laminated insulating layers is not particularly limited as long as it is two or more.

The coil 20 is composed of a plurality of coil conductors (coil conductors 51, 52, 53 and 54 in the example illustrated in FIG. 2) which are electrically connected and embedded in the multilayer body 10. In the example illustrated in FIG. 2, the coil conductors 51, 52, 53 and 54 are laminated together with the insulating layers 41, 42, 43, 44 and 45. Thus, the coil axis of the coil 20 extends along the height direction T.

In the example illustrated in FIG. 2, the coil conductor 51 and the coil conductor 52 are connected by a via conductor 61, the coil conductor 52 and the coil conductor 53 are connected by a via conductor 62, and the coil conductor 53 and the coil conductor 54 are connected by a via conductor 63.

The Outer electrodes 30 are provided on the outer surface of the multilayer body 10 and are electrically connected to the coil 20. The outer electrodes 30 include, for example, a first outer electrode 31 and a second outer electrode 32.

The first outer electrode 31 is, for example, disposed such that as shown in FIG. 1, it covers the first end surface 11 of the multilayer body 10, and extends from the first end surface 11 and covers a part of the first main surface 13, a part of the second main surface 14, a part of the first side surface 15, and a part of the second side surface 16. The second outer electrode 32 is, for example, disposed such that as shown in FIG. 1, it covers the second end surface 12 of the multilayer body 10, and extends from the second end surface 12 and covers a part of the first main surface 13, a part of the second main surface 14, a part of the first side surface 15, and a part of the second side surface 16. In this case, the second main surface 14 can be used as a mounting surface.

Though not shown in FIGS. 1 and 2, it is preferred that the coil conductor 51 constituting the coil 20, for example, be extended to the first end surface 11 of the multilayer body 10, and the coil conductor 54 constituting the coil 20, for example, be extended to the second end surface 12 of the multilayer body 10 so that the first outer electrode 31 is electrically connected to the coil conductor 51 at the first end surface 11, and the second outer electrode 32 is electrically connected to the coil conductor 54 at the second end surface 12.

The position(s) of connection between the coil 20 and the outer electrodes 30 can be changed by changing the position from which the coil conductor 51 or 54 is extended to the outside of the multilayer body 10. Thus, the coil 20 and the outer electrodes 30 may be electrically connected at the end surface(s) of the multilayer body 10, or at the main surface(s) or the side surface(s) of the multilayer body 10.

As shown in FIG. 2, an inorganic material layer 70 is provided in at least part of the interfaces between the insulating layers and the coil conductors. In the example illustrated in FIG. 2, the inorganic material layer 70 is provided at the interface between the insulating layer 41 and the coil conductor 51, at the interface between the insulating layer 42 and the coil conductor 52, at the interface between the insulating layer 43 and the coil conductor 53, and at the interfaces between the insulating layer 44 and the coil conductor 54. The inorganic material layer 70 may be provided in at least one of the interfaces. The inorganic material layer 70 may be provided over the entire area of each interface or in a part of each interface.

Though not shown in FIG. 2, the inorganic material layer 70 may be provided in at least part of the interface between the insulating layer 42 and the coil conductor 51, the interface between the insulating layer 43 and the coil conductor 52, the interface between the insulating layer 44 and the coil conductor 53, and the interface between the insulating layer 45 and the coil conductor 54. The inorganic material layer 70 may be provided in at least one of the interfaces. The inorganic material layer 70 may be provided over the entire area of each interface or in a part of each interface.

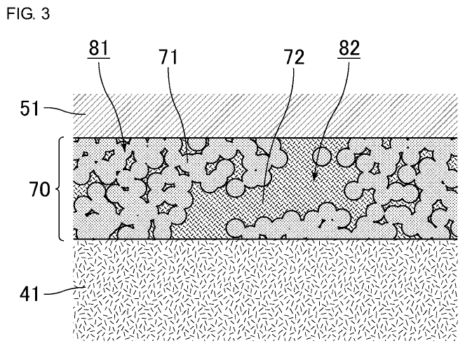

FIG. 3 is a cross-sectional view schematically showing an example of the inorganic material layer.

As shown in FIG. 3, the inorganic material layer 70 comprises an inorganic material 71 and a metal material 72 different from the inorganic material 71. Therefore, the inorganic material layer 70 includes a first region 81 where the inorganic material 71 is present, and a second region 82 where the metal material 72 is present. Though not shown in FIG. 3, the inorganic material layer 70 may further include a third region where the inorganic material 71 and the metal material 72 are absent. The third region in the inorganic material layer 70, where the inorganic material 71 and the metal material 72 are absent, is preferably formed of a void(s) or a cavity(ies).

The provision of the inorganic material layer 70 between an insulating layer and a coil conductor (for example, between the insulating layer 41 and the coil conductor 51) can reduce a stress generated in the multilayer body 10 e.g., due to the difference in thermal contraction coefficient between the insulating layer and the coil conductor.

Since the inorganic material layer 70 comprises not only the inorganic material 71 but the metal material 72 as well, the difference in thermal expansion coefficient between the inorganic material layer 70 and an insulating layer or a coil conductor can be reduced. The thermal expansion coefficient of the inorganic material layer 70 preferably has a value intermediate between the thermal expansion coefficient of the insulating layer and the thermal expansion coefficient of the coil conductor. More preferably, the thermal expansion coefficient of the inorganic material layer 70 has a value which is intermediate between the thermal expansion coefficient of the insulating layer and the thermal expansion coefficient of the coil conductor, and which is within the range of about +30% of the average value of the thermal expansion coefficient of the insulating layer and the thermal expansion coefficient of the coil conductor. Still more preferably, the thermal expansion coefficient of the inorganic material layer 70 has a value which is intermediate between the thermal expansion coefficient of the insulating layer and the thermal expansion coefficient of the coil conductor, and which is within the range of about +10% of the average value of the thermal expansion coefficient of the insulating layer and the thermal expansion coefficient of the coil conductor. The thermal expansion coefficient can be determined, for example, as an average thermal expansion coefficient in a temperature range from room temperature (20° C.) to 600° C. using a thermomechanical analyzer (TMA).

Further, in the inorganic material layer 70, as shown in FIG. 3, the metal material 72 is present between particles of the inorganic material 71 or in/between porous bodies made of the inorganic material 71. That is, in the inorganic material layer, the metal material 72 is at least one of between particles of the inorganic material 71, in porous bodies including the inorganic material 71, or between or among the porous bodies including the inorganic material 71. Therefore, the strength of the multilayer body 10 can be made high as compared to the case where a stress relaxation portion made of powder is provided as described in Japanese Unexamined Patent Application Publication No. 2006-253322 and Japanese Unexamined Patent Application Publication No. 2017-59749 (Japanese Patent No. 6520604).

The thickness of the inorganic material layer 70 is preferably smaller than the thickness of a coil conductor such as the coil conductor 51. When the inorganic material layer 70 is provided at a plurality of interfaces, the thickness of the inorganic material layer 70 may be the same or different among the interfaces.

For example, the thickness of the inorganic material layer 70 may be more than 0 μm and not more than 1.5 μm (i.e., from more than 0 μm to 1.5 μm). When the thickness of the inorganic material layer 70 is not more than 1.5 μm, the resistance is low and the volume of the multilayer body increases relatively, resulting in an improvement of the coil characteristics. In the case where the inorganic material layer 70 is provided at a plurality of interfaces, if the thickness of the inorganic material layer 70 at any one of the interfaces is more than 0 μm and not more than 1.5 μm (i.e., from more than 0 μm to 1.5 μm), then it can be said that the thickness of the inorganic material layer 70 is more than 0 μm and not more than 1.5 μm (i.e., from more than 0 μm to 1.5 μm). Preferably, the thickness of the inorganic material layer 70 is more than 0 μm and not more than 1.5 μm (i.e., from 0 μm to 1.5 μm) at all the interfaces.

When the thickness of the inorganic material layer 70 is more than 0 μm and not more than 1.5 μm (i.e., from more than 0 μm to 1.5 μm), the thickness of the inorganic material layer 70 is preferably at least 25% of the thickness of the coil conductors. In this case, the thickness of the coil conductors is 6.0 μm or less. When the thickness of the coil conductors is relatively small as in this case, a more sufficient stress relaxation effect can be achieved if the thickness of the inorganic material layer 70 is at least 25% of the thickness of the coil conductors. When the thicknesses of the coil conductors are not equal, the proportion of the thickness of the inorganic material layer 70 to the thickness of a coil conductor which is in contact with an interface at which the inorganic material layer 70 is provided may be calculated.

Alternatively, the thickness of the inorganic material layer 70 may be more than 2 μm. When the thickness of the inorganic material layer 70 is more than 2 μm, a greater stress relaxation effect is achieved. In the case where the inorganic material layer 70 is provided at a plurality of interfaces, if the thickness of the inorganic material layer 70 at any one of the interfaces is more than 2 μm, then it can be said that the thickness of the inorganic material layer 70 is more than 2 μm. Preferably, the thickness of the inorganic material layer 70 is more than 2 μm at all the interfaces.

When the thickness of the inorganic material layer 70 is more than 2 μm, the thickness of the inorganic material layer 70 is preferably not more than 15% of the thickness of the coil conductors. In this case, the thickness of the coil conductors is 40/3 μm or more. When the thickness of the coil conductors is relatively large as in this case, the relative volume of the multilayer body can be made large if the thickness of the inorganic material layer 70 is made not more than 15% of the thickness of the coil conductors, resulting in an improvement of the coil characteristics. When the thicknesses of the coil conductors are not equal, the proportion of the thickness of the inorganic material layer 70 to the thickness of a coil conductor which is in contact with an interface at which the inorganic material layer 70 is provided may be calculated.

The thickness of the inorganic material layer 70 and the thickness of a coil conductor each refer to a thickness which, when the multilayer body 10 is polished to approximately the center in the width direction W and observed in the cross-section including the length direction L and the height direction T (also referred to as the LT cross-section), is determined in a direction passing through the center of the width of the coil conductor and parallel to the lamination direction.

The width of the inorganic material layer 70 may be the same as or smaller than the width of a coil conductor, such as the coil conductor 51, when viewed from a direction in which the coil conductor extends. When the inorganic material layer 70 is provided at a plurality of interfaces, the width of the inorganic material layer 70 may be the same or different among the interfaces.

In the inorganic material layer 70, the proportion of the first region 81 to the sum of the first region 81 where the inorganic material 71 is present and the second region 82 where the metal material 72 is present is preferably not less than 20% and not more than 80% (i.e., from 20% to 80%), more preferably not less than 50% and not more than 80% (i.e., from 50% to 80%).

The proportion of the first region 81 and the proportion of the second region 82 in the inorganic material layer 70 can be calculated by determining, when the multilayer body 10 is polished to approximately the center in the width direction W and observed in the cross-section including the length direction L and the height direction T (also referred to as the LT cross-section), the area of the first region 81 where the inorganic material 71 is present and the area of the second region 82 where the metal material 72 is present.

As shown in FIG. 3, the inorganic material layer 70 is preferably bonded to an insulating layer such as the insulating layer 41. This further increases the strength of the multilayer body 10.

As shown in FIG. 3, the inorganic material layer 70 is preferably bonded to a coil conductor such as the coil conductor 51. This further increases the strength of the multilayer body 10.

Examples of the inorganic material 71 include an oxide, a carbide, and a nitride. The inorganic material 71 may be a metal material. Examples of the inorganic material 71 include a magnetic ferrite material, a magnetic metal material, a non-magnetic ferrite material, a glass material, zirconia, forsterite, steatite, yttria, mullite, cordierite, silicon carbide, and silicon nitride. These inorganic materials may be used singly or in a combination of two or more. As used herein, “inorganic material” includes both an inorganic material in the form of particles and an inorganic material in the form of a porous body.

Examples of the metal material 72 include Ag, Cu, and Pd. These metal materials may be used singly or in a combination of two or more.

The insulating layers such as the insulating layer 41 are preferably made of a magnetic ferrite material containing at least Fe, Ni, Zn, and Cu. For example, it is preferred to use a magnetic ferrite material comprising Fe in an amount of not less than 40 mol % and not more than 49.5 mol % (i.e., from 40 mol % to 49.5 mol %) in terms of Fe₂O₃, Zn in an amount of not less than 5 mol % and not more than 35 mol % (i.e., from 5 mol % to 35 mol %) in terms of ZnO, and Cu in an amount of not less than 4 mol % and not more than 12 mol % (i.e., from 4 mol % to 12 mol %) in terms of CuO, the balance being NiO. The magnetic ferrite material may contain small amounts of additives (including unavoidable impurities) such as Mn, Co, Sn, Bi, and Si.

An example of a method for manufacturing the multilayer coil component of the present disclosure will now be described.

A ferrite sheet, a ferrite paste, an inorganic material paste and a conductive paste, for example, are prepared as materials.

A magnetic ferrite material containing at least Fe, Ni, Zn, and Cu is preferably used as a material for the ferrite sheet. Thus, a magnetic ferrite material is preferably used which comprises Fe in an amount of not less than 40 mol % and not more than 49.5 mol % (i.e., from 40 mol % to 49.5 mol %) in terms of Fe₂O₃, Zn in an amount of not less than 5 mol % and not more than 35 mol % (i.e., from 5 mol % to 35 mol %) in terms of ZnO, and Cu in an amount of not less than 4 mol % and not more than 12 mol % (i.e., from 4 mol % to 12 mol %) in terms of CuO, the balance being NiO. The magnetic ferrite material may contain small amounts of additives (including unavoidable impurities) such as Mn, Co, Sn, Bi, and Si.

The ferrite sheet may be produced, for example, by the following method.

Fe₂O₃, ZnO, CuO, NiO, and optionally additives are weighed according to a predetermined composition. The weighed materials are placed, together with pure water, a dispersant, and PSZ (partially stabilized zirconia) media, in a ball mill, and mixed and milled. After drying the resulting slurry, it is calcined under the conditions of a temperature of not less than 700° C. and not more than 800° C. (i.e., from 700° C. to 800° C.), and a calcination time of not less than 2 hours and not more than 3 hours (i.e., from 2 hours to 3 hours).

The resulting calcined powder of ferrite material, an organic binder such as polyvinyl butyral, and an organic solvent such as ethanol or toluene are placed, together with PSZ media, in a ball mill, and mixed and milled. The resulting mixture is formed into a sheet having a predetermined thickness by a doctor blade method, and the sheet is then punched to produce a ferrite sheet having a predetermined size.

A magnetic ferrite material containing at least Fe, Ni, Zn, and Cu is preferably used as a material for the ferrite paste. Thus, a magnetic ferrite material is preferably used which comprises Fe in an amount of not less than 40 mol % and not more than 49.5 mol % (i.e., from 40 mol % to 49.5 mol %) in terms of Fe₂O₃, Zn in an amount of not less than 5 mol % and not more than 35 mol % (i.e., from 5 mol % to 35 mol %) in terms of ZnO, and Cu in an amount of not less than 4 mol % and not more than 12 mol % (i.e., from 4 mol % to 12 mol %) in terms of CuO, the balance being NiO. The magnetic ferrite material may contain small amounts of additives (including unavoidable impurities) such as Mn, Co, Sn, Bi, and Si.

The ferrite paste may be produced, for example, by the following method.

Predetermined amounts of a solvent (such as a ketone solvent), a resin (such as polyvinyl acetal), and a plasticizer (such as an alkyd plasticizer) are added to the calcined powder of ferrite material obtained by the above-described ferrite sheet production method, and the mixture is kneaded in a planetary mixer. The resulting mixture is dispersed using a three-roll mill to produce a ferrite paste.

An inorganic material and a metal material different from the inorganic material are used as materials for the inorganic material paste. It is preferred to use, as the inorganic material, a magnetic ferrite material, a magnetic metal material, a non-magnetic ferrite material, a glass material, zirconia, forsterite, steatite, yttria, mullite, cordierite, silicon carbide, silicon nitride, etc. These inorganic materials may be used singly or in a combination of two or more. Ag, Cu, Pd, etc. are preferably used as the metal material. These metal materials may be used singly or in a combination of two or more.

The inorganic material paste may be produced, for example, by the following method.

Predetermined amounts of a solvent (such as a ketone solvent), a resin (such as polyvinyl acetal), etc. are added to an inorganic material powder and a metal material powder, and the mixture is kneaded in a planetary mixer. The resulting mixture is dispersed using a three-roll mill to produce an inorganic material paste.

A paste containing silver as a conductive material is preferably used as the conductive paste.

The conductive paste may be produced, for example, by the following method.

A silver powder is prepared, and predetermined amounts of a solvent (such as eugenol), a resin (such as ethyl cellulose), and a dispersant are added to the silver powder, and the mixture is kneaded in a planetary mixer. The resulting mixture is dispersed using a three-roll mill to produce a conductive paste.

Next, a multilayer body 10 having a coil 20 inside is manufactured using the above-described materials.

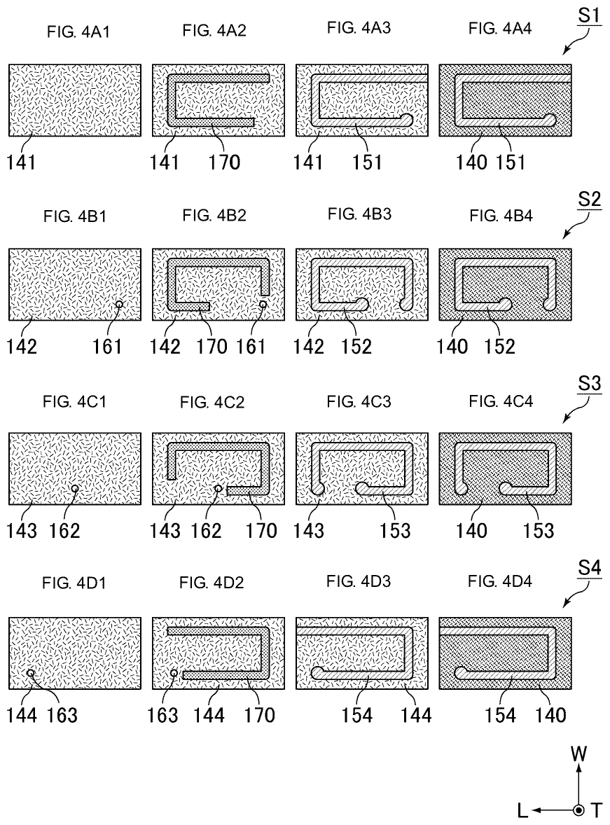

FIGS. 4A1 to 4A4, FIGS. 4B1 to 4B4, FIGS. 4C1 to 4C4, and FIGS. 4D1 to 4D4 are exploded views schematically illustrating an example of a method for producing a multilayer body having a coil inside.

First, a ferrite sheet 141 is prepared (FIG. 4A1).

The inorganic material paste is printed on the ferrite sheet 141 in an area where the inorganic material layer 70 (see FIG. 2) is to be formed, thereby forming an inorganic material paste layer 170 (FIG. 4A2).

The conductive paste is printed on the ferrite sheet 141 in an area where the coil conductor 51 (see FIG. 2) is to be formed, thereby forming a conductive paste layer 151 (FIG. 4A3). As shown in FIG. 4A3, one end of the conductive paste layer 151 is preferably extended to an end surface of the ferrite sheet 141.

The ferrite paste is printed on the area of the ferrite sheet 141 where the conductive paste layer 151 is not formed, thereby forming a ferrite paste layer 140 (FIG. 4A4).

A sheet S1, consisting of the ferrite sheet 141 having the inorganic material paste layer 170, the conductive paste layer 151 and the ferrite paste layer 140, printed on the sheet, is formed through the above steps.

Separately, a ferrite sheet 142 is prepared, and a via hole 161 (FIG. 4B1) is formed by applying a laser beam to a portion to be connected to the conductive paste layer 151 of the sheet S1.

The inorganic material paste is printed on the ferrite sheet 142 in an area where the inorganic material layer 70 is to be formed, thereby forming an inorganic material paste layer 170 (FIG. 4B2).

The conductive paste is printed on the ferrite sheet 142 in an area where the coil conductor 52 (see FIG. 2) is to be formed, thereby forming a conductive paste layer 152 and filling the conductive paste into the via hole 161 (FIG. 4B3).

The ferrite paste is printed on the area of the ferrite sheet 142 where the conductive paste layer 152 is not formed, thereby forming a ferrite paste layer 140 (FIG. 4B4).

A sheet S2, consisting of the ferrite sheet 142 having the via hole 161 and having the inorganic material paste layer 170, the conductive paste layer 152 and the ferrite paste layer 140, printed on the sheet, is formed through the above steps.

By the same procedure as described above for the production of the sheet S2, a sheet S3 (FIGS. 4C1 through 4C4), consisting of a ferrite sheet 143 having a via hole 162 and having an inorganic material paste layer 170, a conductive paste layer 153 and a ferrite paste layer 140, printed on the sheet, and a sheet S4 (FIGS. 4D1 through 4D4), consisting of a ferrite sheet 144 having a via hole 163 and having an inorganic material paste layer 170, a conductive paste layer 154 and a ferrite paste layer 140, printed on the sheet, are produced. As shown in FIG. 4D3, one end of the conductive paste layer 154 is preferably extended to an end surface of the ferrite sheet 144.

The thus-produced sheets S1, S2, S3, and S4 are stacked in a predetermined order, and a predetermined number of ferrite sheets, having no printed paste layer, are stacked on the top and the bottom of the stacked sheets. The resulting stacked sheets are subjected to warm isostatic pressing (WIP) under the conditions of a temperature of not less than 70° C. and not more than 90° C. (i.e., from 70° C. to 90° C.), and a pressure of not less than 60 MPa and not more than 100 MPa (i.e., from 60 MPa to 100 MPa) to obtain a multilayer body block which is an assembly of devices.

Devices are obtained by cutting the multilayer body block into pieces using a dicer or the like. The devices are placed in a firing furnace and fired under the conditions of a temperature of not less than 900° C. and not more than 920° C. (i.e., from 900° C. to 920° C.), and a firing time of not less than 2 hours and not more than 4 hours (i.e., from 2 hours to 4 hours).

After the firing, the ferrite sheet 141 and the ferrite sheets laminated thereunder become the insulating layer 41. The ferrite paste layer 140, printed on the ferrite sheet 141, and the ferrite sheet 142 become the insulating layer 42. The ferrite paste layer 140, printed on the ferrite sheet 142, and the ferrite sheet 143 become the insulating layer 43. The ferrite paste layer 140, printed on the ferrite sheet 143, and the ferrite sheet 144 become the insulating layer 44. The ferrite paste layer 140, printed on the ferrite sheet 144, and the ferrite sheets laminated on the ferrite sheet 144 become the insulating layer 45.

Further, after the firing, the inorganic material paste layer 170 becomes the inorganic material layer 70, the conductive paste layers 151 to 154 become the coil conductors 51 to 54, and the conductive paste that fills the via holes 161 to 163 become the via conductors 61 to 63. The coil conductors 51 to 54 and the via conductors 61 to 63 constitute the coil 20.

Preferably, the edges and corners of the fired device are rounded by placing the device, together with media, in a rotating barrel machine and rotating it. The multilayer body 10 having the coil 20 inside is obtained through the above steps.

A conductive paste containing silver and glass is applied to the end surfaces of the multilayer body 10 to which the coil 20 is extended. The conductive paste is baked at a temperature of not less than 800° C. and not more than 820° C. (i.e., from 800° C. to 820° C.) to form base electrodes of the outer electrodes 30. The thickness of the base electrodes is, for example, about 5 μm.

A Ni film and a Sn film are sequentially formed by electrolytic plating on the base electrodes, thereby forming the outer electrodes 30.

The multilayer coil component 1 as shown in FIG. 1 is thus obtained. The multilayer coil component 1 has, for example, the following dimensions: 0.6 mm in the length direction L, 0.3 mm in the width direction W, and 0.3 mm in the height direction T.

### EXAMPLES

The following examples disclose the multilayer coil component of the present disclosure in greater detail. It is to be noted that the present disclosure is not limited only to the examples.

### Example 1

Fe₂O₃, ZnO, NiO, and CuO were mixed and pulverized in a wet state at a predetermined ratio, and then dried to remove moisture. The resulting dried product was calcined at a temperature of 800° C. for 2 hours to produce a ferrite material which is a magnetic material. A ferrite sheet and a ferrite paste were produced from the thus-obtained magnetic material.

A zirconia powder as an inorganic material and an Ag powder as a metal material, both for forming an inorganic material layer, were prepared. An inorganic material paste was produced using a mixed powder consisting of the zirconia powder and the Ag powder, mixed at a volume ratio of 75:25.

Using the thus-produced ferrite sheet, ferrite paste and inorganic material paste, and an Ag paste, a multilayer coil component was produced by the procedure described above in “Description of Embodiments”, and used as a sample of Example 1.

The thus-produced sample was stood upright such that an LT surface was exposed, and the sample was circumferentially cemented in a resin. Using a polisher, the sample was polished to approximately the center in the W direction. A photograph of the resulting cross-section was taken by a scanning electron microscope (SEM) at a magnification of 10000. Using image processing software, the area of a first region where zirconia was present and the area of a second region where Ag was present in the inorganic material layer were determined. The area measurement was performed at five locations and the average value was calculated. As a result, the proportion of the first region to the sum of the first region and the second region was 75%.

### Comparative Example 1

A multilayer coil component was produced in the same manner as in Example 1 except for using, instead of the inorganic material paste produced in Example 1, an inorganic material paste produced using only a zirconia powder without using an Ag powder, and was used as a sample of Comparative Example 1.

In Comparative Example 1, when the sample was polished in the same manner as in Example 1, drop-off of the zirconia powder from the sample was observed. This fact suggests that in the sample of Comparative Example 1, the zirconia particles as an inorganic material exist in the form of a powder.

A bending strength test was conducted on the sample of Example 1 and the sample of Comparative Example 1. As a result, it was found that the sample of Example 1 had higher bending strength than the sample of Comparative Example 1.

100 samples of Example 1 were produced, and were each polished to approximately the center of the multilayer body 10 in the width direction W. Upon observation of the LT cross-section, there was no formation of cracks, indicating that relaxation of internal stress was effected.

What is claimed is:

1. A multilayer coil component comprising:
a multilayer body including a plurality of laminated insulating layers;
a coil including a plurality of coil conductors laminated together with the insulating layers, embedded in the multilayer body, and the plurality of coil conductors being electrically connected; and
an outer electrode on an outer surface of the multilayer body and electrically connected to the coil,
wherein
an inorganic material layer is in at least a portion of interfaces between the insulating layers and the coil conductors,
the inorganic material layer includes an inorganic material and a metal material different from the inorganic material, and
in the inorganic material layer, the metal material is at least one of
between particles of the inorganic material,
in porous bodies including the inorganic material, or
between or among the porous bodies including the inorganic material.

2. The multilayer coil component according to claim 1, wherein
a thickness of the inorganic material layer is from more than 0 μm to 1.5 μm.

3. The multilayer coil component according to claim 2, wherein
the thickness of the inorganic material layer is equal to or greater than 25% of the thickness of the coil conductor.

4. The multilayer coil component according to claim 1, wherein
a thickness of the inorganic material layer is more than 2 μm.

5. The multilayer coil component according to claim 4, wherein
the thickness of the inorganic material layer is equal to or less than 15% of the thickness of the coil conductor.

6. The multilayer coil component according to claim 1, wherein
the inorganic material comprises at least one selected from the group consisting of a magnetic ferrite material, a magnetic metal material, a non-magnetic ferrite material, a glass material, zirconia, forsterite, steatite, yttria, mullite, cordierite, silicon carbide, and silicon nitride.

7. The multilayer coil component according to claim 6, wherein
the metal material comprises at least one selected from the group consisting of Ag, Cu, and Pd.

8. The multilayer coil component according to claim 1, wherein
in the inorganic material layer, a proportion of a first region where the inorganic material is present to a sum of the first region and a second region where the metal material is present is from 20% to 80%.

9. The multilayer coil component according to claim 1, wherein
the inorganic material layer is bonded to the insulating layers.

10. The multilayer coil component according to claim 1, wherein
the inorganic material layer is bonded to the coil conductors.

11. The multilayer coil component according to claim 1, wherein
the insulating layers include a magnetic ferrite material including at least Fe, Ni, Zn, and Cu.

12. The multilayer coil component according to claim 2, wherein
the inorganic material comprises at least one selected from the group consisting of a magnetic ferrite material, a magnetic metal material, a non-magnetic ferrite material, a glass material, zirconia, forsterite, steatite, yttria, mullite, cordierite, silicon carbide, and silicon nitride.

13. The multilayer coil component according to claim 3, wherein
the inorganic material comprises at least one selected from the group consisting of a magnetic ferrite material, a magnetic metal material, a non-magnetic ferrite material, a glass material, zirconia, forsterite, steatite, yttria, mullite, cordierite, silicon carbide, and silicon nitride.

14. The multilayer coil component according to claim 2, wherein
in the inorganic material layer, a proportion of a first region where the inorganic material is present to a sum of the first region and a second region where the metal material is present is from 20% to 80%.

15. The multilayer coil component according to claim 3, wherein
in the inorganic material layer, a proportion of a first region where the inorganic material is present to a sum of the first region and a second region where the metal material is present is from 20% to 80%.

16. The multilayer coil component according to claim 2, wherein
the inorganic material layer is bonded to the insulating layers.

17. The multilayer coil component according to claim 3, wherein
the inorganic material layer is bonded to the insulating layers.

18. The multilayer coil component according to claim 2, wherein
the inorganic material layer is bonded to the coil conductors.

19. The multilayer coil component according to claim 3, wherein
the inorganic material layer is bonded to the coil conductors.

20. The multilayer coil component according to claim 2, wherein
the insulating layers include a magnetic ferrite material including at least Fe, Ni, Zn, and Cu.
